(19) United States
(12) Patent Application Publication
(10) Pub. No.: US 2004/0187319 A1
(43) Pub. Date: Sep. 30, 2004

(54) Microreplicated shaving surface and a method for making the same

(75) Inventors: Brian G. Balistee, Milford, CT (US); Raymond Guimont, Guilford, CT (US); Randy Nicolosi, Shelton, CT (US); Glennis J. Orloff, Woodbridge, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH (US)

(21) Appl. No.: 10/779,836

(22) Filed: Feb. 17, 2004

Related U.S. Application Data
(60) Provisional application No. 60/448,280, filed on Feb. 19, 2003.

(51) Int. Cl. B26B 21/54

(52) U.S. Cl. 30/346.57

(57) ABSTRACT

A microreplicated shaving surface includes a substrate having a plurality of longitudinal micro-shaving element projected outwardly therefrom. The micro-shaving elements are arranged in at least one row with each element being spaced away from approximately parallel to the next successive micro-shaving element. Each of the plurality of micro-shaving elements defines a cutting edge extending longitudinally thereof for cutting hair from a user's skin during a shaving operation.

### CROSS-REFERENCE TO RELATED APPLICATIONS

This application is entitled to the benefit of and incorporates by reference essential subject matter disclosed in Provisional Patent Application No. 60/448,280 filed on Feb. 19, 2003.

### FIELD OF THE PRESENT INVENTION

The present invention is generally related to devices employed to shave hair from skin, and is more particularly directed to a shaving surface having a plurality of discrete, outwardly projecting shaving elements.

### BACKGROUND OF THE PRESENT INVENTION

Historically, razors used for the removal of hair from skin employed one or more individual blades each having a single longitudinally sharpened edge. These blades have a tendency to cut the user's skin and to otherwise cause discomfort during a shaving operation. In addition, blades configured in this manner, by their very nature, tend to cause handling difficulties during manufacturing. In an effort to minimize the danger related to the exposed cutting edges of these blades, guards have been incorporated into the razor design. The guard is generally interposed between the user's skin and the cutting edge of the razor blade. This allows the cutting edge of the blade to pass over a user's skin and cut hair extending outwardly therefrom while minimizing the potential for nicks and cuts. However, this modification is not entirely effective in preventing injury to the user and does not have any effect with respect to the inherent difficulties associated with handling these blades during razor manufacture.

Blade structures incorporating multiple apertures each having a sharpened edge have also been disclosed in the prior art. However, experience has shown that the expense associated with manufacturing blades of this type is, at present, prohibitive.

Based on the foregoing, it is the general object of the present invention to provide a shaving surface that overcomes the problems and drawbacks of the prior art.

### SUMMARY OF THE INVENTION

The present invention is directed in a first aspect to a microreplicated-shaving surface. As used herein the term “microreplicated” should be construed to mean reproduced a plurality of times on an extremely small or “micro” scale. The microreplicated surface of the present invention includes a substrate having a plurality of longitudinal discrete micro-shaving elements projecting outwardly from a surface thereof. The micro-shaving elements are preferably arranged in at least one row with each shaving element being approximately parallel to and spaced away from the next successive shaving element in the row. Each of the plurality of micro-shaving elements defines a cutting edge that extends longitudinally along the length of the shaving element.

In the preferred embodiment of the present invention, the microshaving elements are formed from cast amorphous metal and are preferably triangular in cross-section with the outermost longitudinal edge forming the cutting edge. The cutting edge is sharpened via electrochemical machining, however, the present invention is not limited in this regard as other sharpening techniques known to those skilled in the pertinent art to which the present invention pertains, can be substituted without departing from the broader aspects of the present invention. Moreover, while casting has been shown and described, the present invention is not limited in this regard as other methods of forming the microshaving elements, such as, but not limited to embossing can also be employed. In addition, while amorphous metal may be preferred, other materials, such as, but not limited to tungsten or stainless steel are also acceptable. Moreover, a polymeric substrate coated with amorphous or other metal at least in the area of the cutting edge is also contemplated by the present invention.

Preferably, the above-described shaving elements each define a leading surface inclined at a first rake angle and a trailing surface inclined at a second rake angle. The first and second rake angles preferably being inclined in a direction generally opposite to the direction in which the shaving surface would be drawn across a user's skin.

An advantage of the present invention is that the miniature nature of the microshaving elements allows the microreplicated-shaving surface to be handled more safely. In addition, the microreplicated shaving surface should yield a closer more comfortable shave as there are a larger number of cutting edges successively engaging a user's hair, with a decrease in the potential for cutting a user's skin.

### BRIEF DESCRIPTION OF THE DRAWINGS

FIG. 1 is a perspective view of the microreplicated-shaving surface of the present invention.

### DETAILED DESCRIPTION OF THE PREFERRED EMBODIMENTS

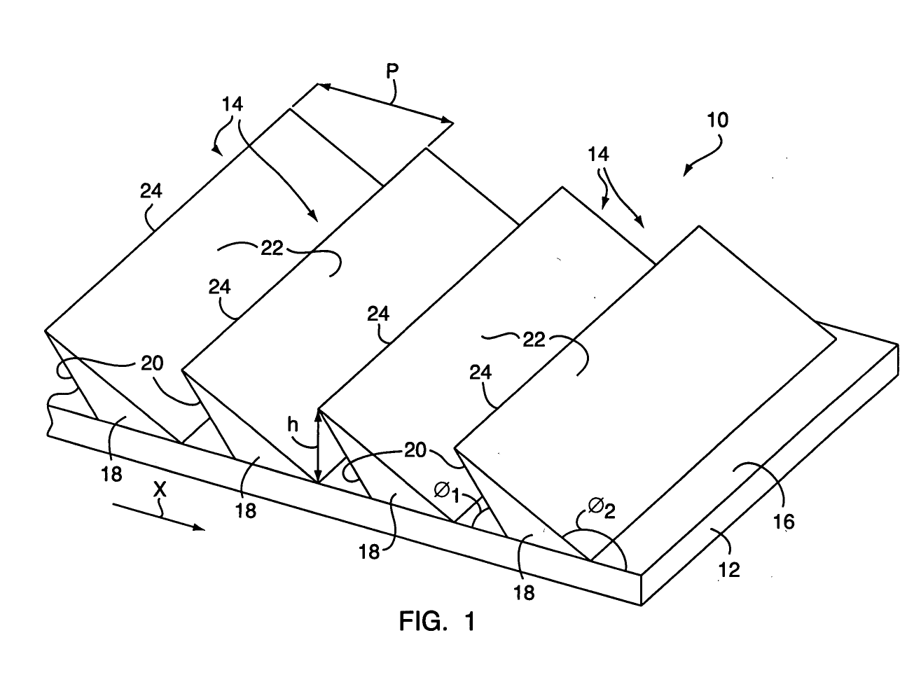

As shown in FIG. 1, a microreplicated shaving surface generally designated by the reference number 10, includes a substrate 12 having a plurality of longitudinal micro-shaving elements, generally designated by the reference number 14 projecting outwardly from a surface 16 thereof. The substrate is made from a suitable material such as, but not limited to amorphous metal. Amorphous metals may be formed by several processes, none of which are the subject of this invention. However, as general background, most amorphous metal manufacturing processes involve the use of liquid quenching techniques in which a melt of an alloy composition is cooled rapidly so that no crystalline structure forms. While amorphous metals have been described, the present invention is not limited in this regard as other materials, such as, but not limited to tungsten or stainless steel can be substituted without departing from the broader aspects of the present invention. In the preferred embodiment of the present invention, the microreplicated shaving surface 10 is generally formed via casting. However, other methods of generally forming the microreplicated shaving surface, such as, but not limited to, grinding or embossing or a combination thereof can also be employed.

The microreplicated shaving surface 10 can also be formed by coating a substrate having the micro-shaving elements 14 formed thereon with an amorphous metal or other coating such as, but not limited to ceramics or other metals. The substrate can be either polymeric, metallic or ceramic.

As shown in the illustrated embodiment, the cross-section 18 of each microshaving element 14 is generally triangular and defines a height “h” from the substrate surface 16 that in the preferred embodiment is approximately, but not limited to, 0.100 inches. In addition, each microshaving element defines a leading surface 20 inclined at a first rake angle Ø₁ and a trailing surface 22 inclined at a second rake angle Ø₂. As used herein, the terms “leading” and “trailing” are to be construed with respect to the direction generally indicated with respect to the arrow labeled “X” in FIG. 1.

The first and second rake angles, Ø₁ Land Ø₂ respectively, can either be different or the same and in the illustrated embodiment are different with Ø₁ being the larger of the two. In addition, while a triangular cross section has been shown and described, the present invention is not limited in this regard as other shaped cross-sections such as polygonal can be substituted.

Each microshaving element 14 defines a longitudinal cutting edge 24, which in the preferred embodiment is sharpened via electrochemical machining. The distance between successive cutting edges, or the pitch, is indicated by the dimension labeled “P” and is preferably, but not limited to approximately 0.100 inches. While electrochemical machining has been described herein, the present invention is not limited in this regard as other machining and forming techniques such as embossing, grinding, or a combination thereof are also contemplated by the present invention.

The shaving surface 10 can be used as the hair-cutting surface in a shaving implement having any number of configurations. For example, the shaving surface 10 can be incorporated into a disposable razor, or into a disposable cartridge adapted to mount onto a razor handle either permanently, or releasably.

While preferred embodiments have been shown and described, one skilled in the pertinent art to which the present invention pertains will immediately recognize that various modifications and substitutions may be made. Accordingly, it is to be understood that the present invention has been described by way of example, and not by limitation.

What is claimed is:

1. A microreplicated shaving surface comprising:
a substrate;
a plurality of longitudinal micro-shaving elements projecting outwardly from a surface of said substrate, said micro-shaving elements being arranged in at least one row with each micro-shaving element being spaced away from and approximately parallel to the next successive micro-shaving element; and wherein
each of said plurality of micro-shaving elements defines a cutting edge extending longitudinally thereof.

2. A microreplicated shaving surface as defined by claim 1 wherein said substrate and said plurality of micro-shaving elements are metallic.

3. A microreplicated shaving surface as defined by claim 2 wherein said substrate and said plurality of micro-shaving elements are formed from amorphous metal.

4. A microreplicated shaving surface as defined by claim 1 wherein said longitudinal micro-shaving elements define a substantially triangular cross section.

5. A microreplicated shaving surface as defined by claim 4 wherein said longitudinal micro-shaving elements each define a leading surface inclined at a first rake angle and a trailing surface inclined at a second rake angle.

6. A microreplicated shaving surface as defined by claim 5 wherein said first and second rake angles are different.

7. A microreplicated shaving surface as defined by claim 5 wherein said first and second rake angles are the same.

8. A microreplicated shaving surface as defined by claim 1 wherein said substrate and said micro-shaving elements are formed from stainless steel.

9. A microreplicated shaving surface as defined by claim 1 wherein said substrate and said micro-shaving elements are formed from tungsten.

10. A microreplicated-shaving surface as defined by claim 1 wherein each of said cutting edges are formed by electro-chemical machining.

11. A microreplicated shaving surface as defined by claim 1 wherein:
said substrate and said plurality of microshaving surfaces are unitary and made from a first material; and
each of said plurality of microshaving elements is at least partially coated with a second material.

12. A microreplicated shaving surface as defined by claim 11 wherein said first material is metallic and said second material is amorphous metal.

13. A microreplicated shaving surface as defined by claim 11 wherein said first material is ceramic and said second material is metallic.

14. A microreplicated shaving surface as defined by claim 11 wherein said first material is metallic and said second material is ceramic.

15. A method for making a microreplicated shaving surface comprising the steps of:
providing a substrate;
processing said substrate to form a plurality of elongated microshaving elements, each having an outwardly facing cutting edge; and
sharpening said cutting edges.

16. A method as defined by claim 15 wherein said step of processing said metallic substrate to form a plurality of elongated microshaving elements includes forming said microshaving elements to have a triangular cross section

17. A method as defined by claim 16 wherein said cutting edge is formed on an outermost edge defined by each microshaving element by electrochemical machining.

18. A method as defined by claim 15 wherein said step of processing said metallic substrate material includes embossing said substrate material to form said microshaving elements.

19. A method as defined by claim 15 wherein said step of providing a substrate includes providing an amorphous metal substrate.

20. A method as defined by claim 15 wherein said step of processing said metallic substrate material includes casting said metallic substrate material to form said microreplicated shaving surface having said plurality of elongated microshaving elements.
